(19) United States
(12) Patent Application Publication
(10) Pub. No.: US 2007/0226041 A1
(43) Pub. Date: Sep. 27, 2007

(54) Method for tailoring a survey to a vehicle

(75) Inventors: Christopher L. Oesterling, Troy, MI (US); Michael L. Peterson, Waterford, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation

(21) Appl. No.: 11/389,758

(22) Filed: Mar. 27, 2006

(51) Int. Cl. G07G 1/00

(52) U.S. Cl. 705/10

(57) ABSTRACT

System(s) and method(s) for tailoring a survey to a vehicle having a telematics unit operatively disposed therein are disclosed. The system(s) and method(s) include the steps of receiving vehicle data, analyzing the vehicle data, and automatically selecting an appropriate survey based upon automatic recognition and analysis of the vehicle data.

### TECHNICAL FIELD

The present disclosure relates generally to soliciting information, and more particularly to a method and system for soliciting information via a telematics system.

### BACKGROUND

Surveys are a useful means for soliciting consumer feedback, which may be very valuable to companies and consumers alike. In some instances, it may be preferable to present a consumer with a survey while that consumer is interacting with the item of interest. In some situations, this may provide the most accurate feedback because the consumer is able to refer to the item of interest while receiving and responding to the survey. Furthermore, a survey may be tailored for and/or targeted to a particular consumer based on the consumer's personal profile or experiences.

Targeting audio messaging to consumers while they are in their vehicles may be a valuable tool and beneficial to both the consumer and the company. Messages that may be targeted include promotions, recall campaign notifications, and vehicle feature education.

The use of a telematics module to take surveys is known in the art. A telematics module allows a survey to be transmitted wirelessly to a consumer. Telematics are a way to present a consumer with a survey in a wide range of locations. Additionally, telematics provide the capability to have a real-time, two-way connection between a consumer and a third party. Telematics may be particularly useful for delivering a survey to a consumer located in a vehicle. Additionally, it is possible for a third party to obtain a consumer's vehicle data and/or information via a telematics module, which may then be analyzed and used to tailor a survey for a vehicle and/or a consumer.

Some potential drawbacks exist with the above-mentioned system. In the known system, a skilled survey delivery person is necessary to analyze the vehicle/user data and deliver a relevant survey to the vehicle operator/passenger. In addition, that or another skilled person must record the survey questions and answers for subsequent processing. Further, it may be difficult to adequately time delivery of the survey(s), e.g. the survey delivery person may attempt to deliver a survey while the vehicle operator is performing difficult/challenging maneuvers.

As such, it would be desirable to provide a survey automatically tailored or configured by vehicle data and a way to present it to a consumer situated in the vehicle.

### SUMMARY

The present disclosure provides a system and method for tailoring a survey to a vehicle. The system and method include the steps of receiving vehicle data, analyzing the vehicle data, and automatically selecting an appropriate survey based upon automatic recognition and analysis of the vehicle data.

### BRIEF DESCRIPTION OF THE DRAWINGS

Objects, features and advantages of embodiments of the present disclosure may become apparent by reference to the following detailed description and drawings, in which like reference numerals correspond to similar, though not necessarily identical components. For the sake of brevity, reference numerals having a previously described function may not necessarily be described in connection with other drawings in which they appear.

FIG. 1 is schematic diagram depicting an embodiment of a system for soliciting consumer feedback;

FIG. 2 is a flow diagram depicting an embodiment of a method for automatically tailoring a survey to a vehicle; and

FIG. 3 is a flow diagram depicting an embodiment of a method for soliciting consumer feedback.

### DETAILED DESCRIPTION

Embodiment(s) of the system and methods disclosed herein advantageously provide for surveys automatically tailored and/or formulated by vehicle data. It is to be understood that, as used herein, “vehicle data” may include, but is not limited to, time of day, environmental conditions, location, data relating to past, present, or predicted future use of the vehicle and/or any subcomponents therein, driving habits of the operator(s), demographic information relating to the operator(s) and/or passenger(s), and/or the like.

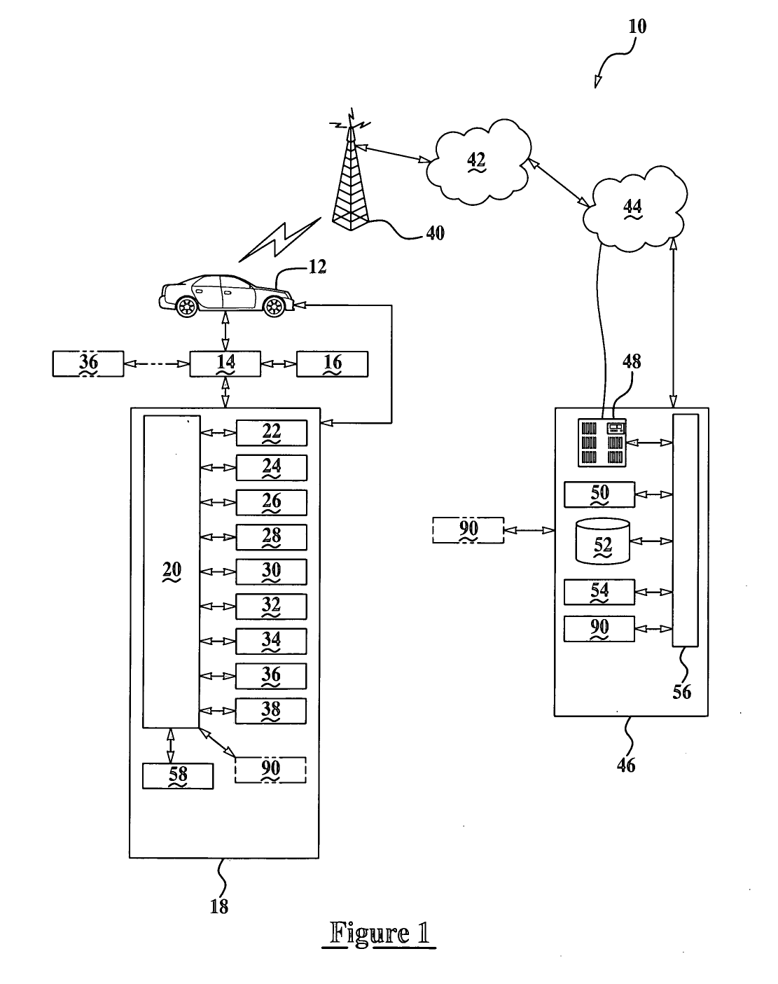

Referring now to FIG. 1, the system 10 includes a vehicle 12, a vehicle communications network 14, a telematics unit 18, a two-way radio frequency communication system (including, but not limited to, one or more wireless carrier systems 40, one or more communication networks 42, and/or one or more land networks 44), and one or more call centers 46. In one embodiment, vehicle 12 is a mobile vehicle with suitable hardware and software for transmitting and receiving voice and data communications. System 10 may include additional components suitable for use in telematics units 18.

In an embodiment, via vehicle communications network 14, the vehicle 12 sends signals from the telematics unit 18 to various units of equipment and systems 16 within the vehicle 12 to perform various functions, such as unlocking a door, executing personal comfort settings, and/or the like. In facilitating interaction among the various communications and electronic modules, vehicle communications network 14 utilizes interfaces such as controller area network (CAN), ISO standard 11989 for high speed applications, ISO standard 11519 for lower speed applications, and Society of Automotive Engineers (SAE) standard J1850 for high speed and lower speed applications.

The telematics unit 18 may send and receive radio transmissions from wireless carrier system 40. In an embodiment, wireless carrier system 40 may be a cellular telephone system and/or any other suitable system for transmitting signals between the vehicle 12 and communications network 42. Further, the wireless carrier system 40 may include a cellular communication transceiver, a satellite communications transceiver, a wireless computer network transceiver (a non-limitative example of which includes a Wide Area Network (WAN) transceiver), and/or combinations thereof.

Telematics unit 18 may include a processor 20 operatively coupled to a wireless modem 22, a location detection system 24 (a non-limitative example of which is a global positioning system (GPS)), an in-vehicle memory 26, a microphone 28, one or more speakers 30, an embedded or in-vehicle mobile phone or TTY compatible mobile phone 32, a vehicle compatible TTY unit 36, and/or a short-range wireless communication network 38 (e.g. a Bluetooth® unit).

It is to be understood that the telematics unit 18 may be implemented without one or more of the above listed components, such as, for example, speakers 30. Yet further, it is to be understood that the speaker(s) 30 may be a component of the vehicle audio system, which may accept audio and other signals from the telematics unit 18. Telematics unit 18 may include additional components and functionality as desired for a particular end use.

Processor 20 may be a micro controller, a controller, a microprocessor, a host processor, and/or a vehicle communications processor. In another embodiment, processor 20 may be an application specific integrated circuit (ASIC). Alternatively, processor 20 may be a processor working in conjunction with a central processing unit (CPU) performing the function of a general-purpose processor.

Non-limitative examples of the location detection system 24 include a Global Position Satellite receiver, a radio triangulation system, a dead reckoning position system, and/or combinations thereof. In particular, a GPS provides accurate time and latitude and longitude coordinates of the vehicle 12 responsive to a GPS broadcast signal received from a GPS satellite constellation (not shown). In-vehicle mobile phone 32 may be a cellular type phone, such as, for example an analog, digital, dual-mode, dual-band, multi-mode and/or multi-band cellular phone.

Associated with processor 20 is a real time clock (RTC) 34 providing accurate date and time information to the telematics unit hardware and software components that may require date and time information. In one embodiment date and time information may be requested from the RTC 34 by other telematics unit components. In other embodiments, the RTC 34 may provide date and time information periodically, such as, for example, every ten milliseconds.

Processor 20 may execute various computer programs that interact with operational modes of electronic and mechanical systems within the vehicle 12. It is to be understood that processor 20 controls communication (e.g. call signals) between telematics unit 18, wireless carrier system 40, and call center 46.

Further, processor 20 may generate and accept digital signals transmitted between the telematics unit 18 and the vehicle communication network 14, which is connected to various electronic modules in the vehicle 12. In one embodiment, these digital signals activate the programming mode and operation modes within the electronic modules, as well as provide for data transfer between the electronic modules. In another embodiment, certain signals from processor 20 may be translated into vibrations and/or visual alarms.

It is to be understood that software 58 may be associated with processor 20 for monitoring and/or recording the incoming caller utterances.

The communications network 42 may include services from one or more mobile telephone switching offices and/or wireless networks. Communications network 42 connects wireless carrier system 40 to land network 44. Communications network 42 may be any suitable system or collection of systems for connecting the wireless carrier system 40 to the vehicle 12 and the land network 44.

The land network 44 connects the communications network 40 to the call center 46. In one embodiment, land network 44 is a public switched telephone network (PSTN). In another embodiment, land network 44 is an Internet Protocol (IP) network. In still other embodiments, land network 44 is a wired network, an optical network, a fiber network, another wireless network, and/or any combinations thereof. The land network 44 may be connected to one or more landline telephones. It is to be understood that the communications network 42 and the land network 44 connect the wireless carrier system 40 to the call center 46.

Call center 46 contains one or more data switches 48, one or more communication services managers 50, one or more communication services databases 52 containing subscriber profile records and/or subscriber information, one or more communication services advisors 54, and one or more network systems 56.

Switch 48 of call center 46 connects to land network 44. Switch 48 transmits voice or data transmissions from call center 46, and receives voice or data transmissions from telematics unit 18 in vehicle 12 through wireless carrier system 40, communications network 42, and land network 44. Switch 48 receives data transmissions from, or sends data transmissions to one or more communication service managers 50 via one or more network systems 56.

Call center 46 may contain one or more service advisors 54. In one embodiment, service advisor 54 may be human. In another embodiment, service advisor 54 may be an automaton.

Verbal communication may take place via microphone 28 coupled to the in-vehicle or mobile phone 32 associated with the telematics unit 18. Caller utterances into the microphone 28 are received at a call center 46, which tokenizes the utterance stream for further processing. In one embodiment, the tokenized utterances are placed in a subscriber information database 52 at the call center 46.

Physically initiating a navigation route request may be accomplished via a button press, touch screen, or the like located in the vehicle 12. It is to be understood that the button press or touch screen is operatively connected to the telematics unit 18. Upon the user's initiation of the button press or touch screen, the telematics unit 18 signals the call center 46 of the fact that the user has initiated a request.

A user may inform the call center 46 of his/her desired destination. The user may also inform the call center 46 of his/her current position, or alternately, the call center 46 may locate the vehicle's current position via the GPS unit 24.

In an embodiment, the requested navigation route is generated at the call center 46 via an electronic route generator 90. It is to be understood that any other suitable route generator 90 may be used to produce the requested navigation route, including a route generator 90 located onboard the vehicle 12 or located external to the call center 46. The navigation route is generated in the form of textual instructions and/or audio prompts.

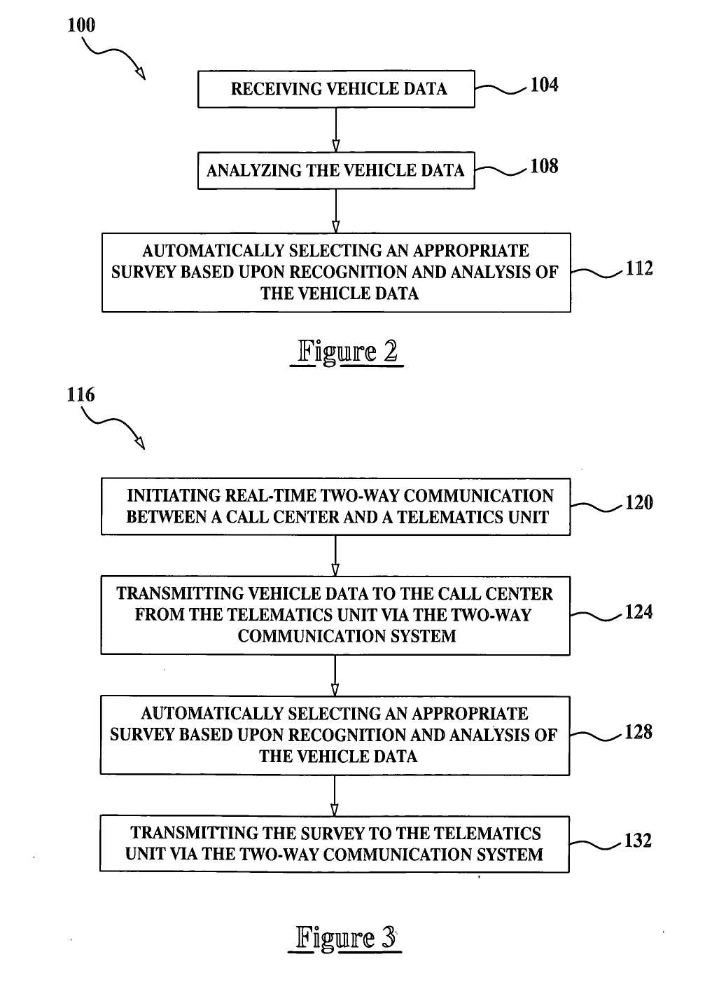

Referring now to FIG. 2, an embodiment of a method 100 for tailoring a survey to a vehicle 12 is depicted. The method 100 includes the steps of receiving vehicle data, as depicted at 104; analyzing the vehicle data, as depicted at 108; and automatically selecting an appropriate survey based upon recognition and analysis of the vehicle data, as depicted at 112.

As used herein, it is to be understood that the term(s) “recognition and analysis,” “analysis,” “analyze,” “analyzing,” and/or any variant thereof is/are intended to encompass varying degrees of analysis, ranging from relatively simple analysis (a non-limitative example of which includes recognition of a vehicle identification number (VIN) and/or information associated with a VIN) to relatively more complex analyses (non-limitative examples of which are described further herein).

The method 100 may also include the preliminary step of initiating communication with the vehicle 12, which may include a request for vehicle data. Initiating communication with the vehicle 12 may be done by a call center 46 via a two-way communication system, such as, for example, the wireless carrier system 40, the one or more communication networks 42, and/or the one or more land networks 44. Alternatively, the vehicle 12 may initiate communication with the call center 46. For example, an internal event, such as a predetermined distance value stored in the telematics unit 18 memory 26 may trigger a call from the telematics unit 18 to the call center 46.

It is to be understood that “automatically” is to be defined broadly and refers to an automated (such as, for example, computerized) system for tailoring a survey, a system whereby a survey is automatically selected (such as, for example, by a human) based upon inputs (such as, for example, vehicle data), and other systems that include an automated and/or automatic step. It is contemplated that “automatic/automatically/automated” include methods and systems that function both with and without human interaction.

The vehicle data may be received by a call center 46 via the two-way communication system. The two-way communication system may be in contact with the telematics unit 18, which may be operatively disposed in the vehicle 12. Vehicle data may include, as non-limitative examples, VIN, internal driving conditions, external driving conditions, vehicle status, recent vehicle operation, data relating to past, present, or predicted future use of the vehicle and/or any subcomponents therein, driving habits of the operator(s), demographic information relating to the operator(s) and/or passenger(s), assumed identity of operator (gleaned from seat/mirror position), and/or the like. Non-limitative examples of vehicle data may include frequency of use of a feature, climate ambient to the vehicle 12, frequency of operation in a specific range of speeds, and/or frequency of operation in stop-and-go circumstances or traffic. It is also to be understood that the step of receiving vehicle data 104 may include receiving data from more than one vehicle 12. Data may be retrieved from the vehicle 12 by the telematics unit 18 and stored, for example, in the telematics unit 18 memory 26. As an example, data may be retrieved by the telematics unit 18 from the vehicle 12 via the vehicle communications network 14.

In an embodiment, the telematics unit 18 may be operatively disposed within the vehicle 18 and adapted to transmit and receive at least one signal. Furthermore, the call center 46, which also is adapted to transmit and receive at least one signal, may be in operative communication with the telematics unit 18 via the two-way communication system. As such, a system for soliciting consumer feedback may include an automated system operatively engaged with the call center 46. In an embodiment, the automated system is adapted to formulate a survey based upon receipt and analysis of the signal(s) from the telematics unit 18 and to transmit the survey to the telematics unit 18 via the two-way communication system.

It is to be understood that a signal may be embodied in any form that can be transmitted via the two-way communication system. As a non-limitative example, in an embodiment, the signal that the telematics unit 18 is adapted to transmit, and the call center 46 is adapted to receive, may include vehicle data. In another embodiment, the signal that the telematics unit 18 is adapted to receive, and the call center 46 is adapted to transmit, may include an automatically tailored survey.

The survey described herein may include at least one question relating to, as non-limitative examples, customer satisfaction and/or vehicle performance. Survey questions may, in other embodiments, be tailored to the vehicle 12, current driving conditions, and/or environment. Non-limitative examples of potential survey question topics include: “feel of the steering wheel in your hands,” “ability to see the gauges and instruments easily,” ability to easily use steering-column controls (e.g. turn signals),” and “accessibility of the window/door lock controls.” If the survey is directed toward nighttime driving, non-limitative examples of survey question topics include: “how well the controls are illuminated at night” and “usefulness of the interior courtesy lights.”

The length of the survey may be adjusted by drive time. For example, the survey may be lengthened if the vehicle 12 is slowed or stopped in traffic, for a bridge opening, for a railway crossing, and/or the like. Further, if based upon previous usage, a drive pattern may be established, certain tailored surveys may be automatically delivered at specific times. For example, if it is determined that the operator is in stop and go/rush hour traffic every weekday between 6:15 am and 6:45 am, a relevant/tailored survey may be automatically delivered during that time period.

The survey may be adapted to be distributed to a vehicle occupant whereby it may be distributed in any manner that presents the survey to the occupant, such as, for example, audibly and/or visually. It is to be understood that an audibly distributed survey may be transmitted through speakers 30 adapted for use with devices such as an in-vehicle stereo and/or communications systems, speakers 30 being specifically adapted for use with the hereindescribed methods and system, and/or the like.

It is to be understood that the method 100 may further include the step of selecting at least one target consumer based upon recognition and analysis of the vehicle data. As such, it is contemplated that a group of consumers may be selected as potential survey recipients based upon a commonality of vehicle data. For example, if a particular survey is related to the use of a specific vehicle 12 feature, vehicle data from one or more vehicles 12 could determine which vehicle(s) 12 have used this feature in the recent past, and the survey could be offered to only those drivers.

FIG. 3 depicts a method 116 for soliciting consumer feedback. The method 116 comprises the steps of initiating real-time two-way communication, via the two-way communication system, between a call center 46 and a telematics unit 18, as depicted at 120; transmitting vehicle data to the call center 46 from the telematics unit 18 via the two-way communication system, as depicted at 124; automatically selecting an appropriate survey based upon recognition and analysis of the vehicle data, as depicted at 128; and transmitting the survey to the telematics unit 18 via the two-way communication system, as depicted at 132. It is to be understood that the survey may be transmitted in audible form and/or in visual form. In an embodiment, the survey is transmitted in audible form.

In embodiment(s) described herein, the survey solicits a class of information including, but not limited to VIN, internal driving conditions, external driving conditions, vehicle status, recent vehicle operation, and/or the like, as described hereinabove. It is to be understood that the telematics unit 18 may be operatively disposed within the vehicle 12.

The method 116 may further include the step of transmitting the consumer feedback from the telematics unit 18 via the two-way communication system, as described hereinabove.

It is to be understood that the consumer feedback may be embodied in any form that can be received and analyzed by the call center 46. Non-limitative examples of consumer feedback include verbal feedback and written feedback. In an embodiment, verbal feedback is received by the microphone 28 disposed within the vehicle cockpit and transmitted to the telematics unit 18 for further transmittal. Further transmittal of verbal feedback may be received by a speech recognition engine residing at the call center 46. In another example, verbal feedback may be transformed by the telematics unit 18 before further transmission. For example, a verbal annunciation may be “three” uttered by a survey taker. The utterance “three” may be transformed into an eight bit byte representing “three” in preparation for further transmission. Written feedback may be, for example, handwritten or typed and/or may be selected from a group of predetermined responses via a button, toggle, switch, and/or the like. Both verbal and written feedback may, for example, be received by the call center 46 in real-time or on a delay.

The consumer feedback may be analyzed for a class of feedback including, but not limited to, customer satisfaction and/or vehicle performance.

As discussed hereinabove, the step of initiating real-time two-way communication between the call center 46 and the telematics unit 18, as depicted at 120, may be performed by the call center 46.

The step of transmitting vehicle data may be performed in response to a request for the vehicle data from the call center 46. For example, the call center 46 may transmit a signal via the two-way communication system to the telematics unit 18 requesting a specific set of vehicle data, or all vehicle data recently collected (or collected in a defined time frame) by the vehicle 12.

In an embodiment, the step of transmitting the survey to the telematics unit 18, as depicted at 132 may further include transmitting the survey to an audio system, an LCD (Liquid Crystal Diode) display, an LED (Light Emitting Diode) display, a driver information center display, a radio display, an arbitrary text device, a heads-up display (HUD), a vacuum fluorescent display, and/or the like. As such, further transmitting the survey to the hereinabove devices may be performed as a step of distributing the survey to the consumer.

It is to be understood that the terms “connected/connects/connecting to,” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected/ing to” the other component is somehow in operative communication with the other component (notwithstanding the presence of one or more additional components therebetween). For example, the telematics unit 18 is considered to be connected to the call center 46, although the wireless carrier system 40 may be disposed therebetween.

It is to be understood that, as defined herein, a consumer may include vehicle operators and/or passengers.

While several embodiments have been described in detail, it will be apparent to those skilled in the art that the disclosed embodiments may be modified. Therefore, the foregoing description is to be considered exemplary rather than limiting.

1. A method for tailoring a survey to a vehicle having a telematics unit operatively disposed therein, the method comprising:
receiving vehicle data;
analyzing the vehicle data; and
automatically selecting an appropriate survey based upon the vehicle data.

2. The method of claim 1 wherein the vehicle data is received by a call center via a two-way communication system in operative communication with the telematics unit.

3. The method of claim 1 wherein prior to receiving the vehicle data, the method further includes initiating communication with the vehicle.

4. The method of claim 3 wherein communication is initiated by a call center via a two-way communication system.

5. The method of claim 4, further comprising requesting transmission of the vehicle data to the call center.

6. The method of claim 1 wherein the survey includes at least one question relating to a topic selected from consumer satisfaction, vehicle performance, and combinations thereof.

7. The method of claim 1 wherein vehicle data is selected from vehicle identification number (VIN), internal driving conditions, external driving conditions, vehicle status, recent vehicle operation, and combinations thereof.

8. The method of claim 1 wherein the survey is adapted to be delivered to a vehicle occupant.

9. The method of claim 8 wherein the survey is adapted to be delivered audibly.

10. The method of claim 1, further comprising the step of selecting at least one target consumer based upon automatic recognition and analysis of the vehicle data.

11. The method of claim 1 wherein the vehicle data is received from a plurality of vehicles.

12. A method for soliciting consumer feedback, comprising:
initiating real-time two-way communication, via a two-way communication system, between a call center and a telematics unit operatively disposed within a vehicle;
transmitting vehicle data to the call center from the telematics unit via the two-way communication system;
automatically selecting an appropriate survey based upon automatic recognition and analysis of the vehicle data; and
transmitting the survey to the telematics unit via the two-way communication system;
wherein the survey solicits a class of information selected from vehicle identification number (VIN), interior driving conditions, exterior driving conditions, vehicle status, recent vehicle operation, and combinations thereof.

13. The method of claim 12, further comprising the step of transmitting consumer feedback from the telematics unit via the two-way communication system.

14. The method of claim 13 wherein the consumer feedback is analyzed for a class of feedback selected from consumer satisfaction, vehicle performance, and combinations thereof.

15. The method of claim 12 wherein transmitting the vehicle data is performed in response to a request for the vehicle data from the call center.

16. The method of claim 12 wherein initiating the real-time two-way communication is performed by the call center.

17. The method of claim 12 wherein the two-way communication system includes a wireless carrier system.

18. The method of claim 12 wherein transmitting the survey to the telematics unit further comprises transmitting the survey to at least one of an audio system, an LCD display, an LED display, a driver information center display, a radio display, an arbitrary text device, a heads-up display (HUD), and a vacuum fluorescent display.

19. A system for soliciting consumer feedback, the system comprising:
a telematics unit operatively disposed within a vehicle and adapted to transmit and receive at least one signal;
a call center in operative communication with the telematics unit via a two-way communication system and adapted to transmit and receive at least one signal; and
an automated system, adapted to automatically receive and analyze the at least one signal from the telematics unit to tailor a survey in response to the at least one signal received from the telematics unit, and further adapted to transmit the survey to the telematics unit via the two-way communication system.
